(19) United States
(12) Patent Application Publication
(10) Pub. No.: US 2009/0270135 A1
(43) Pub. Date: Oct. 29, 2009

(54) Handheld device

(75) Inventors: Ken Shoji, Kawasaki (JP); Shigeru Yamaguchi, Kawasaki (JP); Yoshiya Matsumoto, Kawasaki (JP); Manabu Sotodate, Kawasaki (JP); Hiroshi Kobayashi, Kawasaki (JP); Ryou Hattori, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/382,823

(22) Filed: Mar. 24, 2009

(30) Foreign Application Priority Data
Apr. 28, 2008 (JP) 2008-117855

(51) Int. Cl. H04B 1/38

(52) U.S. Cl. 455/566

(57) ABSTRACT

A flexible cable establishes an electric connection between a stationary-side housing and a movable-side housing. The flexible cable is integratedly fabricated with two gasket seals that maintain the inside of the stationary-side housing and the movable-side housing, respectively, in a waterproof condition. A reinforcing plate is laid inside a housing of a movable-side front case to prevent a driver circuit board of a LCD module from getting damaged.

### CROSS-REFERENCE TO RELATED APPLICATIONS

This application is based upon and claims the benefit of priority of the prior Japanese Patent Application No. 2008-117855, filed on Apr. 28, 2008, the entire contents of which are incorporated herein by reference.

### BACKGROUND

1. Field

The present invention relates to a handheld device in which a coupling unit having two-shaft hinge structure is used to couple a stationary-side housing and a movable-side housing, and particularly relates to a handheld device in which waterproofing measures are taken with respect to a flexible cable that is used to electrically connect the movable-side housing and the stationary-side housing.

2. Description of the Related Art

In recent years, to meet manufacturing demands of slim and compact cellular phones, many cellular phones include a coupling unit having two-shaft hinge structure for coupling two housings (a stationary-side housing and a movable-side housing). For example, in a cellular phone that includes a coupling unit having two-shaft hinge structure for coupling the two housings, a thin coaxial cable is attached to a circuit board in the stationary-side housing and is used to electrically connect the stationary-side housing and the movable-side housing (e.g., see Japanese Patent Application Laid-open No. H11-330731).

A thin coaxial cable that electrically connects the two housings is manufactured by bundling a plurality of loose wires. Thus, there is a possibility of cable disconnection while laying the coaxial cable in the housings. Moreover, generally, waterproofing measures are not taken with respect to such a thin coaxial cable. Thus, instead of using a thin coaxial cable, there is a trend in recent years to use a flexible cable for establishing an electric connection between the stationary-side housing and the movable-side housing.

However, in a typical cellular phone, even if a flexible cable is used instead of a thin coaxial cable to establish an electric connection between the stationary-side housing and the movable-side housing coupled by a coupling unit having two-shaft hinge structure, waterproofing measures are not taken with respect to the flexible cable as well.

As described above, the coupling unit having two-shaft hinge structure (i.e., including a two-shaft hinge module) is used to couple the movable-side housing to the stationary-side housing. The two-shaft hinge module is fixed in a recessed area formed on the outside of a stationary-side front case of the stationary-side housing. As a result, unlike in the case of the outside of the stationary-side front case, the inside (front side) of the stationary-side front case becomes convex in shape. Such a configuration forces reduction in the size of the circuit board (about 80 mm long) thereby causing deterioration in the antenna characteristics of the cellular phone.

### SUMMARY

It is an object of the present invention to at least partially solve the problems in the conventional technology.

According to an aspect of an embodiment, a handheld device includes a movable-side housing that includes a movable-side front case in which a liquid crystal display module is arranged and a movable-side rear case; a stationary-side housing that includes a stationary-side front case in which an antenna and a circuit board are arranged and a stationary-side rear case in which a battery pack casing unit is arranged for housing a battery pack; and a coupling unit having two-shaft hinge structure that couples the movable-side housing and the stationary-side housing. A flexible cable is connected to the circuit board in the stationary-side front case and is used to establish an electric connection with the movable-side housing. The flexible cable is integratedly arranged with a first gasket seal and a second gasket seal that maintain the movable-side housing and the stationary-side housing, respectively, in a waterproof condition. The first gasket seal is fixed in a gasket groove formed on the movable-side front case, and the second gasket seal is fixed in a gasket groove formed on the stationary-side front case.

According to another aspect of an embodiment, a handheld device includes a movable-side housing that includes a movable-side front case in which a liquid crystal display module is arranged and a movable-side rear case; a stationary-side housing that includes a stationary-side front case in which an antenna and a circuit board are arranged and a stationary-side rear case in which a battery pack casing unit is arranged for housing a battery pack; and a coupling unit having two-shaft hinge structure that couples the movable-side housing and the stationary-side housing. A driver circuit board of the liquid crystal display module in the movable-side front case is disposed at a front end in the movable-side front case and a resistant sheet metal plate is laid over a whole surface inside a housing of the movable-side front case. A flexible cable is connected to the circuit board in the stationary-side front case and is used to establish an electric connection with the movable-side housing. The flexible cable is integratedly arranged with a first gasket seal and a second gasket seal that maintain the movable-side housing and the stationary-side housing, respectively, in a waterproof condition. The first gasket seal is fixed in a gasket groove formed on the movable-side front case, and the second gasket seal is fixed in a gasket groove formed on the stationary-side front case.

Additional objects and advantages of the invention (embodiment) will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 is an external perspective view of a cellular phone in an open state according to a first embodiment;

FIG. 2 is a top view of the cellular phone shown in FIG. 1;

FIG. 3 is an exploded perspective diagram of a movable-side housing;

FIG. 4 is an enlarged perspective view of the top portion of FIG. 3;

FIG. 5 is an enlarged perspective view of the bottom portion of FIG. 3;

FIG. 6 is an enlarged view of portion A shown in FIG. 5;

FIG. 7 is an exploded perspective view of a stationary-side housing;

FIG. 8 is an enlarged perspective view of the top portion of FIG. 7;

FIG. 9 is an enlarged perspective view of the bottom portion of FIG. 7; and

FIG. 10 is an enlarged perspective view for explaining configuration of a terminal holder.

### DETAILED DESCRIPTION OF THE PREFERRED EMBODIMENTS

An exemplary embodiment of the present invention is described in detail below with reference to the accompanying drawings. In the exemplary embodiment, description is given for a cellular phone as a handheld device. The present invention is not limited to the exemplary embodiment.

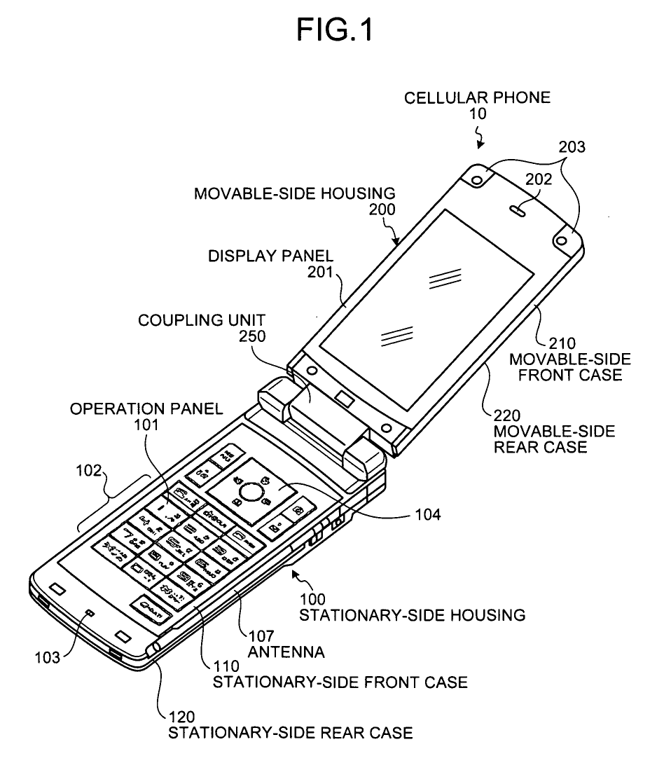

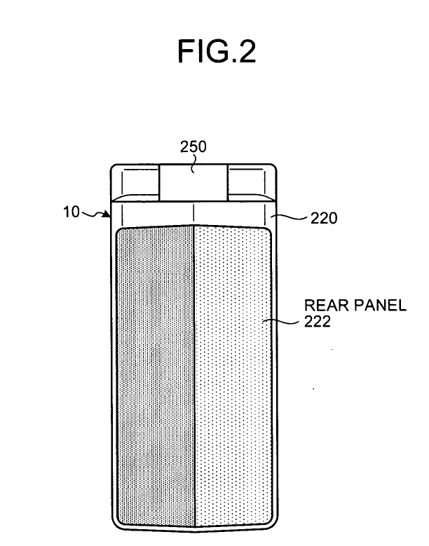

Given below is the description of an exemplary configuration of a cellular phone 10 with reference to FIG. 1. FIG. 1 is an external perspective view of the cellular phone 10 in an open state according to a first embodiment of the present invention. FIG. 2 is a top view of the cellular phone 10 shown in FIG. 1. As shown in FIG. 1, the cellular phone 10 includes a palm-size stationary-side housing 100 and a movable-side housing 200. The stationary-side housing 100 and the movable-side housing 200 are coupled by a coupling unit 250.

More particularly, in the cellular phone 10 shown in FIG. 1, the stationary-side housing 100 is used to talk during a telephone call and has a plurality of operating keys such as a numerical keypad 102 with number keys (from 0 to 9) and a function key 104 (mode setting key). The movable-side housing 200 is fabricated to have a substantially identical size to that of the stationary-side housing 100. The coupling unit 250 couples the movable-side housing 200 to the stationary-side housing 100 in a foldable manner.

The stationary-side housing 100 is a two-fraction structure of a stationary-side front case 110 on the front side and a stationary-side rear case 120 on the rear side (the downside in FIG. 1). The stationary-side front case 110 includes an operation panel 101 in which the operation keys such as the numerical keypad 102 and the like are arranged.

More particularly, as shown in FIG. 1, the stationary-side front case 110 includes the numerical keypad 102, the function key 104, and a mouthpiece 103 having a microphone to convert voice of the user into electric signals. The stationary-side front case 110 and the stationary-side rear case 120 are clamped together at four positions by using spanning screws (not shown).

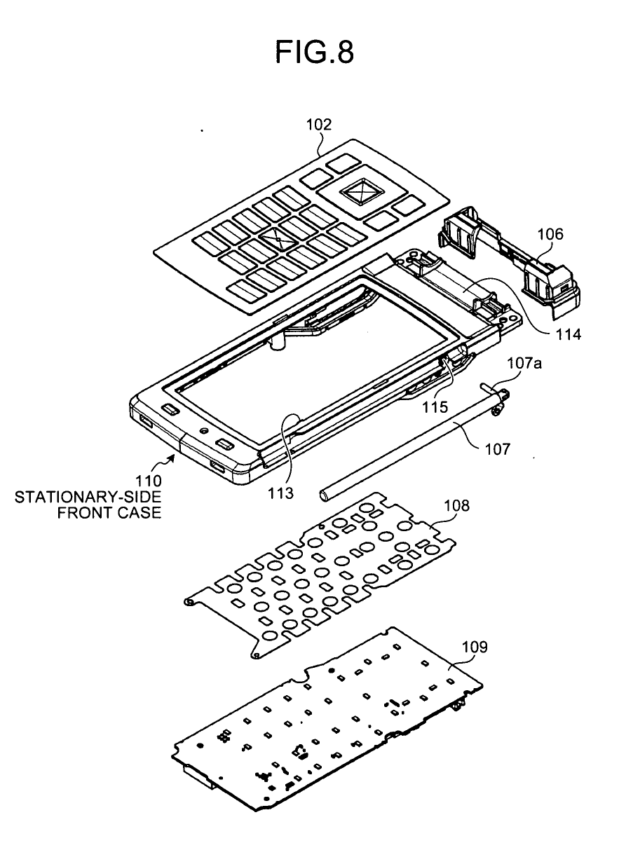

An antenna 107 for receiving one-segment broadcast is fixedly attached to a lateral surface of the stationary-side front case 110. More particularly, an antenna shaft 107a of the antenna 107 is inserted through an attaching hole 115 created on the stationary-side front case 110 (see FIG. 8) and fixed inside the stationary-side front case 110.

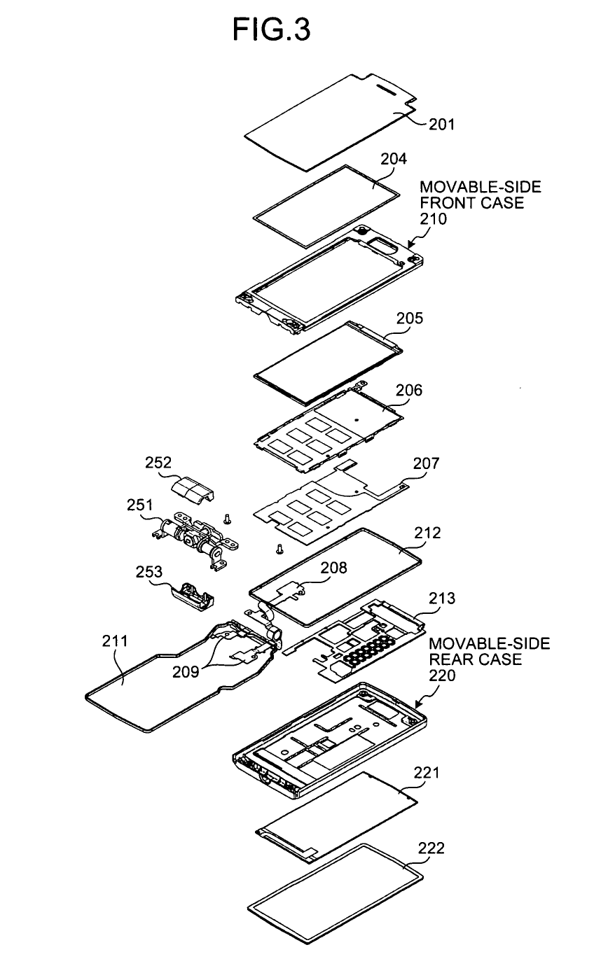

The movable-side housing 200 is a two-fraction structure of a movable-side front case 210 on the front side and a movable-side rear case 220 on the rear side (downside in FIG. 1). As shown in FIG. 1, a large-size display panel 201 is arranged in the substantially central portion of the movable-side front case 210. The display panel 201 is used for viewing the display output by an LCD module 205 (see FIG. 3).

An earpiece 202 is disposed in the top portion of the movable-side front case 210. The earpiece 202 catches the voice of the person on the other end of the line during a conversation. The movable-side front case 210 and the movable-side rear case 220 are clamped at four positions by using spanning screws (not shown). The spanning screws in the top portion of the display panel 201 are covered by screw covers 203.

A rear panel 222 (see FIG. 2) is attached to the outside surface of the movable-side rear case 220.

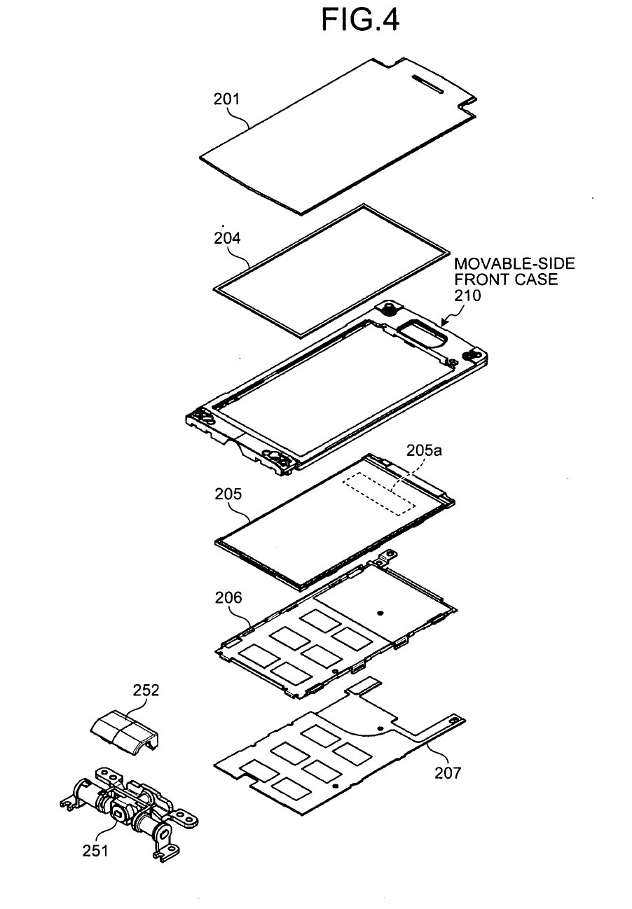

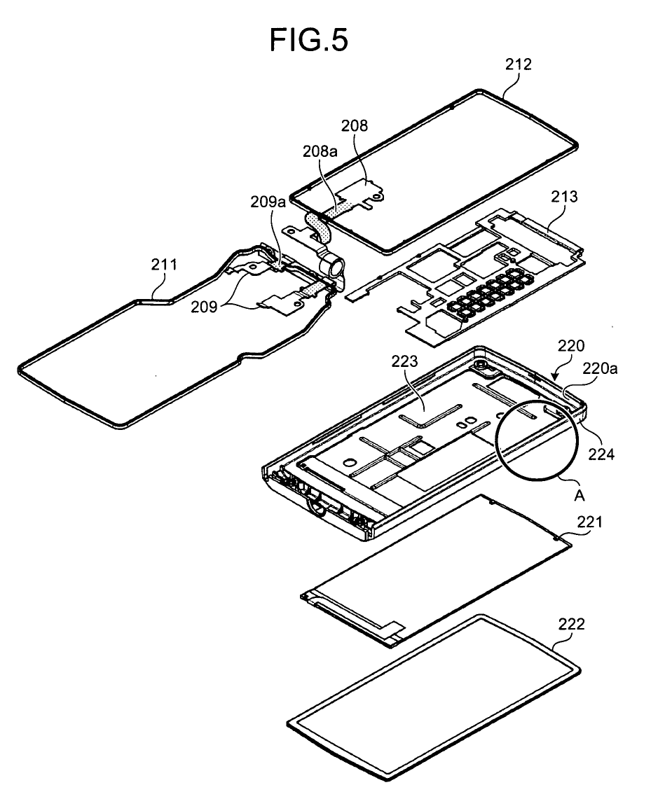

Given below is the description of the configuration of the movable-side housing 200 with reference to FIGS. 3 to 5. FIG. 3 is an exploded perspective diagram of the movable-side housing 200. FIG. 4 is an enlarged perspective view of the top portion of FIG. 3. FIG. 5 is an enlarged perspective view of the bottom portion of FIG. 3.

As shown in FIGS. 3 to 5, the movable-side housing 200 includes from the top the display panel 201, an LCD dustproof packing sheet 204, the movable-side front case 210, and the LCD module 205. In the first embodiment, by taking into consideration the field of view of the display panel 201 (see FIG. 1), a driver circuit board 205a of the LCD module 205 is arranged on the front side of the LCD module 205. An LCD shied packing 206 and a movable-side frame 207 are laminatedly arranged beneath the LCD module 205.

Moreover, the movable-side housing 200 includes a flexible cable 208, an antenna flexible cable 209, a pair of gasket seals 211 and 212, and a movable LED frame 213 made of ABS resin. The movable-side rear case 220, an LCD module 221, and the rear panel 222 are arranged as a laminated structure.

Furthermore, there are a two-shaft hinge module 251, a hinge case 252 disposed as a hinge protecting case on the top of a two-shaft hinge module 251, and a hinge case 253 disposed as a hinge protecting case at the bottom of the two-shaft hinge module 251. The two-shaft hinge module 251 is fixed in a recessed plate 114 (see FIG. 8) on the stationary-side front case 110.

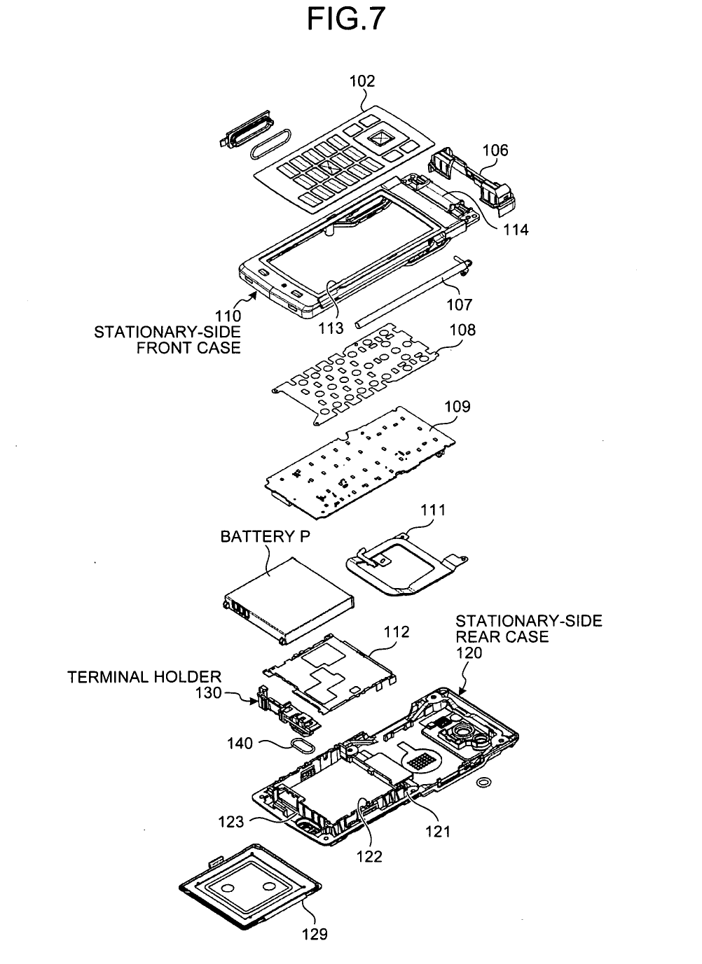

In the first embodiment, to maintain the waterproofing property of the cellular phone 10, the flexible cable 208 in the movable-side front case 210 of the movable-side housing 200 is connected to a circuit board 109 (FIG. 7) arranged in the stationary-side front case 110 in order to establish an electrical connection therebetween and the flexible cable 208 is integratedly fabricated with the gasket seals 211 and 212. As a result, the inside of the stationary-side housing 100 and the inside of the movable-side housing 200 is maintained in a waterproof condition.

More particularly, as shown in FIGS. 3 to 5, the flexible cable 208 and the antenna flexible cable 209 are covered with a seal 208a and a seal 209a, respectively (see FIG. 5). The gasket seal 212, which is fabricated in a rectangular shape, is integratedly connected to the rear end of the flexible cable 208.

Similarly, the gasket seal 211, which is also fabricated in a rectangular shape, is integratedly connected to the antenna flexible cable 209 arranged opposite to the flexible cable 208.

From among the gasket seals 211 and 212, the gasket seal 211 is fixed in a gasket groove 116 on the stationary-side front case 110 (see FIG. 8), while the gasket seal 212 is fixed in a gasket groove 220a of the movable-side rear case 220. In this way, by integratedly arranging the flexible cable 208 and the gasket seal 211 as well as integratedly arranging the antenna flexible cable 209 and the gasket seal 212, it is possible to robustly maintain the waterproof property of the stationary-side housing 100 and the movable-side housing 200.

The movable-side rear case 220 is fabricated in a thin box-like shape, and includes a square case body 223 and a lateral plate casing 224 surrounding the case body 223. In the first embodiment, because the coupling unit 250 has a two-shaft hinge structure, the driver circuit board 205a of the LCD module 205 (see FIG. 4) is arranged on the front side of the movable-side rear case 220. Thus, to prevent the driver circuit board 205a from getting damaged, a reinforcing plate 227 is laid in the movable-side rear case 220.

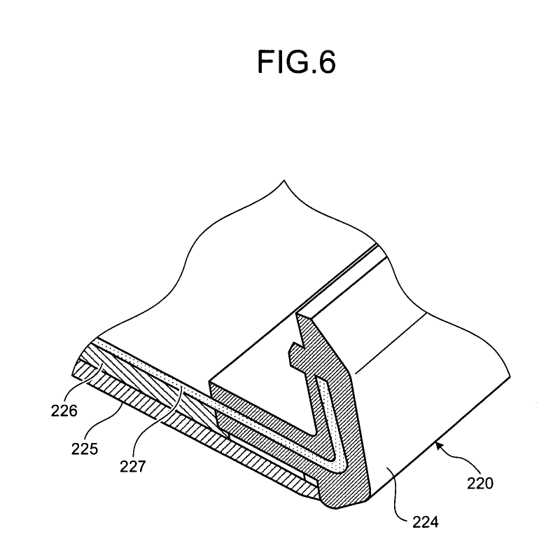

More particularly, as shown in FIG. 6, the movable-side rear case 220 has a three-layer structure of a basement layer 225, an intermediate layer 226, and the reinforcing plate 227. The reinforcing plate 227 provides strength to the movable-side rear case 220.

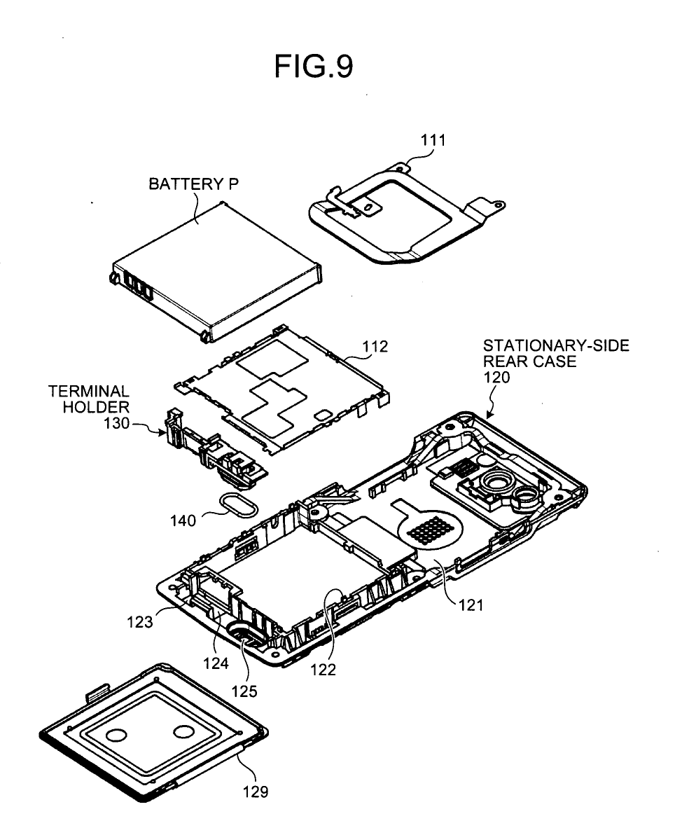

Given below is the description with reference to FIGS. 7 to 9 of the configuration of the stationary-side housing 100. FIG. 7 is an exploded perspective view of the stationary-side housing 100. FIG. 8 is an enlarged perspective view of the top portion of FIG. 7. FIG. 9 is an enlarged perspective view of the bottom portion of FIG. 7.

As shown in FIGS. 7 to 9, the stationary-side housing 100 includes from the top the numerical keypad 102 of the operation panel 101, the stationary-side front case 110, the antenna 107 for receiving one-segment broadcast, a dome sheet 108, a stationary-side rear case packing 109, an antenna element 111, a battery P, a speaker holder 112, a terminal holder 130, and an O-ring 140. The stationary-side rear case 120 includes a battery casing unit 122 covered by a rear cover 129.

As shown in FIG. 8, the stationary-side front case 110 is fabricated in a thin box-like shape and is made of, although not limited to, magnesium alloy, which is light in weight but high in strength. A rectangular opening 113 is created on the stationary-side front case 110 such that the numerical keypad 102 fits in the rectangular opening 113. The recessed plate 114 is fabricated in the top portion of the body of the stationary-side front case 110. The two-shaft hinge module 251 (see FIG. 4) fits in the recessed plate 114. The two-shaft hinge module 251 is fixedly covered by a stationary-side hinge cover 106.

As shown in FIG. 9, a terminal holder receiving unit 123 is fabricated at an end (toward downside in FIG. 9) of the battery casing unit 122, which is disposed on-a case body 121 of the stationary-side rear case 120. The terminal holder receiving unit 123 includes a rectangular holder body receiving member 124 and a horizontally ellipsoidal charging terminal receiving member 125. The terminal holder 130 is plugged into the terminal holder receiving unit 123.

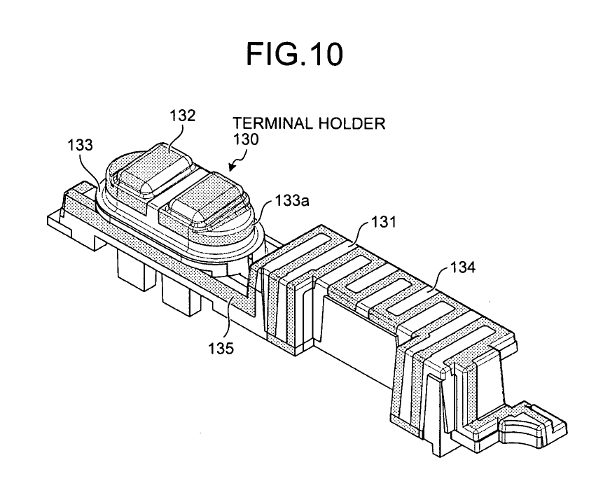

In the first embodiment, the electrical circuit of a pair of charging terminals 132 (see FIG. 10) disposed in the terminal holder 130, which functions as an electrical connection point for the battery P, is used as an electrical ground circuit line for enhancing the antenna reception characteristics.

Generally, the dimensions of a circuit board for attaching an antenna in a cellular phone are about 90 mm in longitudinal direction (¼-th of wavelength of 800 MHz) and about 40 mm in width direction (¼-th of wavelength of 2 GHz). Because the board dimensions are ¼-th of the wavelengths, radio waves of 800 MHz resonate in the longitudinal direction and radio waves of 2 GHz resonate in the width direction.

However, in the case of the cellular phone 10 according to the first embodiment, because the coupling unit 250, which includes the two-shaft hinge module 251 (see FIG. 4) as the two-shaft hinge structure, is used to couple the movable-side housing 200 to the stationary-side housing 100, the dimension of the circuit board for attaching an antenna is little shorter at about 80 mm in the longitudinal direction.

In that case, there is a possibility of deterioration in the antenna characteristics. To solve such a problem, according the first embodiment, a plating pattern is applied to the pair of charging terminals 132 in the terminal holder 130 and the length of the circuit board is electrically maintained to be about 90 mm. As a result, the wavelength of 800 MHz resonates efficiently thereby enhancing the antenna characteristics. Given below is the detailed description of the terminal holder 130 with reference to FIG. 10.

FIG. 10 is a perspective view for explaining the configuration of the terminal holder 130. The shaded portion in FIG. 10 indicates the plating pattern (silver plating pattern). As shown in FIG. 10, a terminal holder body 131 of the terminal holder 130 includes a rectangular supporting platform 135 and an engaging salient portion 134 fabricated adjacent to the supporting platform 135. A supporting salient portion 133 is fabricated on the supporting platform 135. The pair of charging terminals 132 is disposed on the supporting salient portion 133.

In this way, by using the pair of charging terminals 132 of the terminal holder 130 as the electrical ground circuit line for the antenna, it is possible to improve the antenna characteristics. Meanwhile, the O-ring 140 (see FIG. 9) fits in a circumference 133a of the supporting salient portion 133. The O-ring 140 is used to maintain the stationary-side housing 100 in a waterproof condition.

As described above in the first embodiment, the cellular phone 10 includes the flexible cable 208 that establishes an electric connection between the stationary-side housing 100 and the movable-side housing 200. The flexible cable 208 is integratedly fabricated with the gasket seals 211 and 212, which maintain the inside of the stationary-side housing 100 or the movable-side housing 200 in a waterproof condition, and is fixed inside the movable-side front case 210 as well as inside the stationary-side front case 110. Because of such a configuration, it becomes possible to maintain the waterproof property of the cellular phone 10 having two-shaft hinge structure as well as enhance its antenna characteristics.

Although the invention has been described with respect to the first embodiment, the appended claims are not to be thus limited but are to be construed as embodying all modifications and alternative constructions that may occur to one skilled in the art that fairly fall within the basic teaching herein set forth.

The handheld device in the first embodiment is assumed to be a cellular phone. However, the present invention is not limited to the exemplary embodiment. The present invention can also be applied to a small-size information processing device such as a personal digital assistant (PDA), or a small-size music player, or a portable television, or a handheld gaming device.

Thus, according to the embodiments, a flexible cable in a handheld device is integratedly arranged with a first gasket seal and a second gasket seal that maintain a stationary-side housing or a movable-side housing in a waterproof condition. A reinforcing sheet metal plate is laid inside a housing of a movable-side front case. As a result, it is possible to robustly maintain the waterproof property of the handheld device and strengthen the housing of the movable-side front case. That facilitates in arranging a driver circuit board of a liquid crystal display module on the front end in the movable-case front case.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A handheld device comprising:
a movable-side housing that includes a movable-side front case in which a liquid crystal display module is arranged and a movable-side rear case;
a stationary-side housing that includes a stationary-side front case in which an antenna and a circuit board are arranged and a stationary-side rear case in which a battery pack casing unit is arranged for housing a battery pack; and
a coupling unit having two-shaft hinge structure that couples the movable-side housing and the stationary-side housing, wherein
a flexible cable is connected to the circuit board in the stationary-side front case and is used to establish an electric connection with the movable-side housing,
the flexible cable is integratedly arranged with a first gasket seal and a second gasket seal that maintain the movable-side housing and the stationary-side housing, respectively, in a waterproof condition,
the first gasket seal is fixed in a gasket groove formed on the movable-side front case, and
the second gasket seal is fixed in a gasket groove formed on the stationary-side front case.

2. The handheld device according to claim 1, wherein
the battery pack casing unit in the stationary-side rear case includes a terminal holder on which a charging terminal is fixed for supplying electric power of the battery pack to the circuit board, and
a ground circuit pattern is provided on the terminal holder for electrically connecting with the antenna and forming an electrical ground circuit line for the antenna.

3. The handheld device according to claim 2, wherein a circular groove is formed on an end of the terminal holder and a waterproofing O-ring is fixed in the circular groove.

4. The handheld device according to claim 2, wherein the ground circuit pattern forming the electrical ground circuit line for the antenna is a silver plating pattern.

5. A handheld device comprising:
a movable-side housing that includes a movable-side front case in which a liquid crystal display module is arranged and a movable-side rear case;
a stationary-side housing that includes a stationary-side front case in which an antenna and a circuit board are arranged and a stationary-side rear case in which a battery pack casing unit is arranged for housing a battery pack; and
a coupling unit having two-shaft hinge structure that couples the movable-side housing and the stationary-side housing, wherein
a driver circuit board of the liquid crystal display module in the movable-side front case is disposed at a front end in the movable-side front case and a resistant sheet metal plate is laid over a whole surface inside a housing of the movable-side front case,
a flexible cable is connected to the circuit board in the stationary-side front case and is used to establish an electric connection with the movable-side housing,
the flexible cable is integratedly arranged with a first gasket seal and a second gasket seal that maintain the movable-side housing and the stationary-side housing, respectively, in a waterproof condition,
the first gasket seal is fixed in a gasket groove formed on the movable-side front case, and
the second gasket seal is fixed in a gasket groove formed on the stationary-side front case.

6. The handheld device according to claim 5, wherein the sheet metal plate laid inside the housing of the movable-side front case is fabricated in a substantially L shape in accordance with side geometry of the movable-side front case.

7. The handheld device according to claim 6, wherein a reinforcing plate is laid at a front end of the housing of the movable-side front case to cover a rear face of the liquid crystal display module and strengthen the housing.

8. The handheld device according to claim 5, wherein
the battery pack casing unit in the stationary-side rear case includes a terminal holder on which a charging terminal is fixed for supplying electric power of the battery pack to the circuit board, and
a ground circuit pattern is provided on the terminal holder for electrically connecting with the antenna and forming an electrical ground circuit line for the antenna.

9. The handheld device according to claim 8, wherein a circular groove is formed on an end of the terminal holder and a waterproofing O-ring is fixed in the circular groove.

10. The handheld device according to claim 8, wherein the ground circuit pattern forming the electrical ground circuit line for the antenna is a silver plating pattern.
